(19) United States
(12) Patent Application Publication
(10) Pub. No.: US 2016/0182556 A1
(43) Pub. Date: Jun. 23, 2016

(54) SECURITY RISK SCORE DETERMINATION FOR FRAUD DETECTION AND REPUTATION IMPROVEMENT

(71) Applicants: Igor Tatourian, San Jose, CA (US); Naveen Chand Bachkethi, San Jose, CA (US); Hong C. Li, El Dorado Hills, CA (US); Rita H. Wouhaybi, Portland, OR (US)

(72) Inventors: Igor Tatourian, San Jose, CA (US); Naveen Chand Bachkethi, San Jose, CA (US); Hong C. Li, El Dorado Hills, CA (US); Rita H. Wouhaybi, Portland, OR (US)

(21) Appl. No.: 14/581,077

(22) Filed: Dec. 23, 2014

(51) Int. Cl. H04L 29/06

(52) U.S. Cl. CPC H04L 63/1433; H04L 63/1425

(57) ABSTRACT

A technique allows a system to determine online user activity for a user associated with a user client device. The online user activity includes private content, publicly available content and content shared to a social group related to the user. The system determines a social behavior risk score, a social score, and a security risk score for the user and the content they share with others, and provides one or more recommendations to the user in response to determining the social behavior risk score and the security risk score for the user.

### TECHNICAL FIELD

Embodiments described herein generally relate to an online reputation score for a user, and more particularly to a system and method for determining a social behavior score and a security risk score of a user that is used for personal online social risk status improvement and online fraud detection.

### BACKGROUND ART

Today, social network sites have become a popular resource for many people to stay in touch with friends by sharing information with these friends. In addition to sharing information through these social network sites, a person may also share photos and messages with others through email, through Short Message Service (SMS-text messaging), or the like. However, the increase in use and popularity of social networks has had negative consequences. For example, sharing personal online content that is inflammatory or indecent such as, for example, sharing compromising personal photos, have negatively affected a user's online reputation with their friends and peers. Further, sharing compromising content through social networking sites, email, text messages or the like may also negatively impact the sharer's professional career since more employers are using publicly available online social profiles and online content to glean information about a potential candidate or an employee in order to make employment decisions regarding hiring, retention or termination. Private information that is disseminated today to “trustworthy” friends may make the owner of the photographs or other individuals identified in these photographs vulnerable in the future. Since trust relationships with friends may unfortunately erode over time, information shared with trustworthy friends today may surface later when these people are no longer in the sharer's circle of trust. Without the benefit of hindsight, more people are subjecting themselves to security risks by sharing compromising information. Incidentally, more people are now interested in knowing and understanding the risks of sharing information with others and how it may potentially affect their professional careers and perception with others.

A prior art solution that looks at online information has focused on collecting user-generated content for a user from multiple disparate social network platforms. The collected content is then used to provide a social influence score about the person with respect to how the person is viewed by others. However, this social influence scores does not provide a correlation to other users in the social network, nor does it provide a mechanism for the user to improve his social influence score or address how user action may negatively affect his social score. Other prior art solutions focus on enforcing security policies by looking at trust levels of the user client devices or applications. However, these solutions do not address security profiles and user behavior. A way of monitoring a user's activity that may be used to reduce a user's online security risk and to also improve the user's online personal reputation would be desirable.

### BRIEF DESCRIPTION OF DRAWINGS

FIG. 1 is a block diagram illustration a system for determining social and security risk scores for a user according to one embodiment.

FIG. 2 is a block diagram illustrating a system architecture for use with techniques described herein according to one embodiment.

FIG. 3 is a graphic representation of an example user interface for displaying social and security risk information for a user according to one embodiment.

FIG. 4 is a flowchart illustrating a technique for monitoring user-generated content by a user according to one embodiment.

FIG. 5 is a flowchart illustrating a technique for determining a social behavior score and a security risk score for a user according to one embodiment.

FIG. 6 is a diagram illustrating a computing device for use with techniques described herein according to one embodiment.

FIG. 7 is a block diagram illustrating a computing device for use with techniques described herein according to another embodiment.

FIG. 8 is a diagram illustrating a network of programmable devices according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “computer system” can refer to a single computer or a plurality of computers working together to perform the function described as being performed on or by a computer system.

As used herein, the term “social score” can refer to a social influence score that measures a size of a user's online social network and correlates user-generated content with how this user-generated content affects others' moods and emotions within the user's online social network. The social score also reflects how the person is viewed by others who obtain the user's generated content online.

As used herein, the term “social behavior score” can refer to a score that measures a risk of user behavior in sharing content with another person or persons and the other person's reputation for sharing or leaking the content with other people, either intentionally or unintentionally (e.g., unintentionally via malware)

As used herein, the term “security risk score” can refer to a score that measures exploitability of a user based upon the user's online activity such as visiting malicious websites or the user's content that may be disseminated through his relationships in social networking websites.

As used herein, the term “cloud services” can refer to services made available to users on demand via the Internet from a cloud computing provider's servers that are fully managed by a cloud services provider.

As used herein, the term “malware” refers to any software used to disrupt operation of a programmable device, gather sensitive information or gain access to private systems or networks. Malware includes computer viruses (including worms, Trojan horses, etc.), ransomware, spyware, adware, scareware and any other type of malicious program.

A technique allows a client computing system to generate content and hardware and software sensors may monitor user-generated content including text, images, metadata in images or the like. Also, a risk of sharing the content with other people may be determined, including determining if the content is deemed appropriate to share online with the other person. A warning message may be provided to the user if the content is inappropriate based on the user's social behavior score and/or security risk score. Also, a technique for fraud detection and online social risk status improvement may be provided that utilizes a social behavior score and a security risk score of a user. Online user activity is monitored and information about peer groups may be anonymized to determine social norms for generally acceptable behavior. A social score for the user may be determined by accessing social networking sites and by using Natural Language Processing (NLP) on the posted information to classify whether the information is positive or negative while a social behavior score may de determining by determining the risk to user of sharing the information with others as it relates to the other person reputation for leaking or disseminating information, either intentionally or unintentionally (e.g., via malware). Also, a security risk score for user may be determined by evaluating user behavior with respect to visiting websites or downloading online applications to a user client device and performing suspicious activity by using anonymizing software or making multiple unsuccessful attempts to access a plural number of websites online or the like.

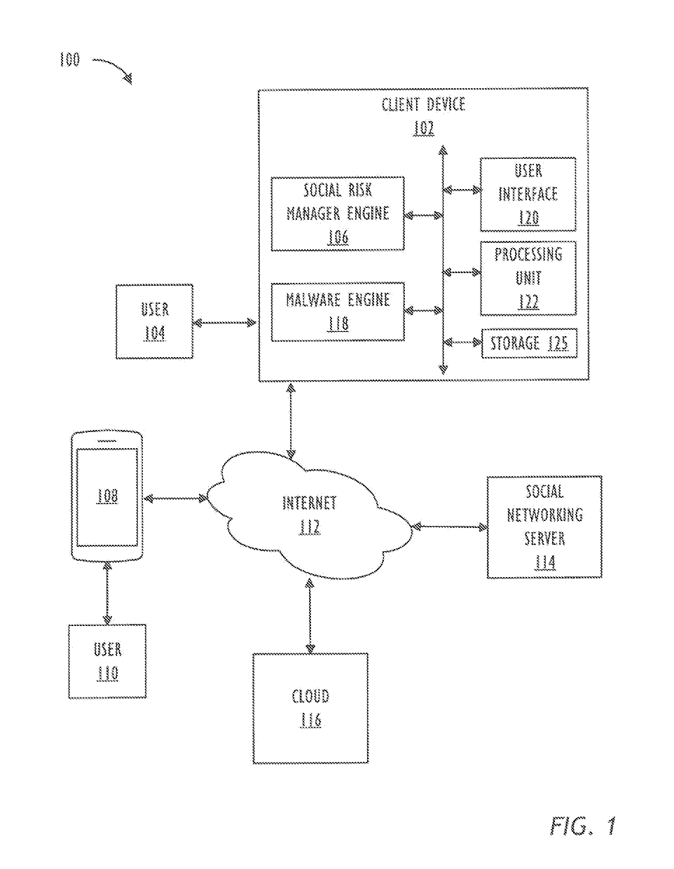

Referring to the figures, FIG. 1 illustrates an example system 100 for determining a social score, a social behavior score and security risk score of a user according to one embodiment. System 100 may include a plurality of user client devices 102 and 108, social networking server 114 and cloud 116 that are communicatively coupled via one or more networks, for example, coupled via Internet 112. In the example of FIG. 1, user client devices 102, 108, which may be accessed by respective users 104 and 110, may be substantially similar or different and can include mobile devices such as, for example, a smart phone, a tablet device, a portable digital assistant as well other computers, including a portable computer and a desktop computer. User client device 102 includes a processing unit 122 that is configured to execute instructions associated with one or more algorithms and computer programs stored in memory 124. User client device 102 may interact with user client device 108 directly through near field communications (NFC), via Bluetooth wireless communication, or the like or indirectly via Internet 112. It is to be appreciated that Internet 112 is not limited to a network of interconnected computer networks that use an internet protocol (IP), and can also include other high-speed data networks and/or telecommunications networks that are configured to pass information back and forth to client devices 102, 108, social networking server 114 and cloud 116.

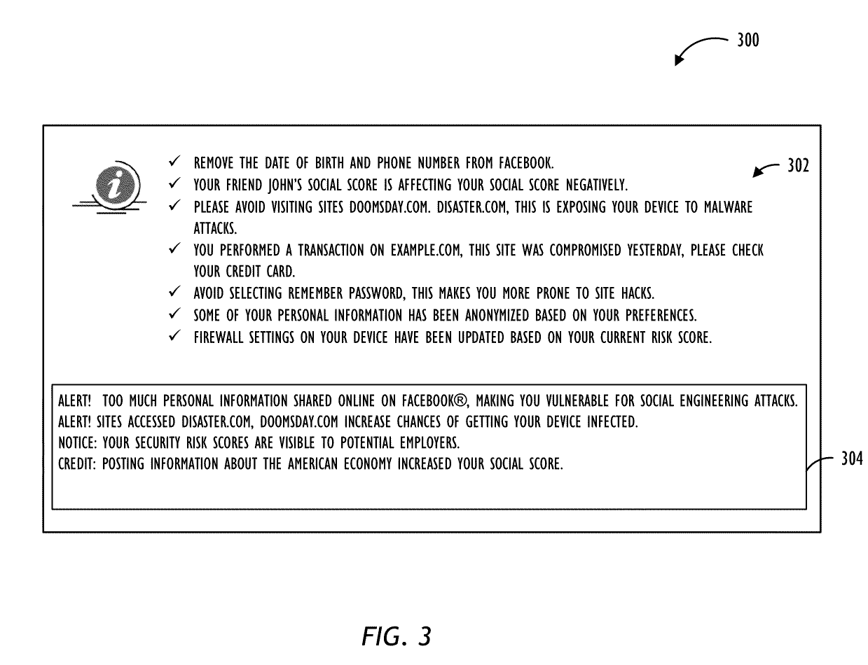

User client device 102 may include social risk manager engine 106 and malware engine 118. Social risk manager engine 106 may be configured to receive information from cloud 116 that can be used to determine a user 104's social behavior and security risk scores. Social risk manager engine 106 may also be configured to provide recommendations in a graphical user interface 120 that relates to improving social behavior and security risk scores for a user 104. Recommendations can include providing suggestions for making changes to existing online content and user behavior as well as providing information related to user activity that generated the social behavior score for user 104. In an embodiment, user 104 may set user preferences on client device 102 that determine how often the user 104 may receive recommendations, alerts and warnings from social risk manager engine 106 via user interface 120 or other interfaces in client device 102. Other embodiments may include setting user preferences that determine preventing user 104 from transmitting or communicating the content based on the severity of the content to be inflammatory. Additionally, social risk manager engine 106 may learn user preferences by evaluating past user behavior when receiving alerts, receiving warnings and receiving recommendations. An example of a graphical user interface 120 that provides user recommendations is depicted below in FIG. 3.

Malware engine 118 may be configured to receive information regarding user 104's security risk score. Malware engine 118 may be configured to either relax or tighten scanning for malware on user client device 102 by considering the security risk score of user 104 during scanning. For example, if the security risk score of a user is low, malware engine 118 may make scanning less intensive (i.e., scanning for performance) of user client device 102 and thereby putting a lesser burden on computing resources of user client device 102 and providing a better user experience. In the case of a higher risk score, malware engine 118 may perform a more rigorous scanning of user client device 102 thereby burdening computing resources.

Also depicted in FIG. 1, user client device 102 is communicatively coupled to cloud 116. Cloud 116 may be embodied as a cloud services system. Cloud 116 may be configured to monitor user activity regarding user 104 on Internet 112 including monitoring private user-generated content disseminated by user 104 and monitoring user-generated information that is publicly disseminated by other third-party users on social networking sites. Cloud 116 may be configured to determine social and security risk scores of user 104 based on this monitored activity. As used herein, the term “user activity” can refer to sharing information or content between user 104 and other users on social networking sites, through email, weblogs, SMS text messages, online shopping and other user transactions. Cloud 116 may be configured to provide information regarding security risk score of user 104 to social risk manager engine 106 including providing information to social risk manager engine 106 regarding the security risk score of user 104. Also, social networking server 114 may be associated with one or more social networking sites, for example, the Facebook® social networking site (FACEBOOK is a registered trademark of Facebook, Inc.).

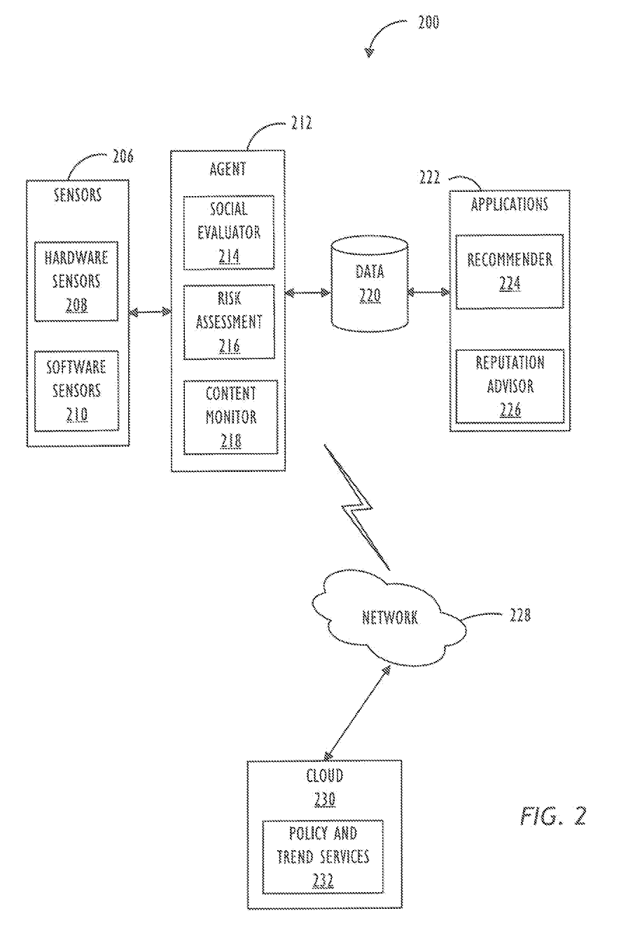

FIG. 2 illustrates an example system architecture 200 that may be used to monitor a user's social risk status (e.g., a user's social risk with respect to others or peer groups). and online image according to one embodiment. Particularly, system architecture 200 may be utilized for monitoring a user's social risk status and online image through social behavior and security risk scores that may be used for online reputation improvement and for security fraud detection of user 104 of user client device 102, as such FIG. 1 is also referenced in the description of FIG. 2. As shown in FIG. 2, system architecture 200 may include sensors 206, agent 212, data storage 220, applications 222 and cloud service system 230 (hereinafter “cloud 230”).

Sensors 206 may be configured to monitor user activity on client device 102 and in cloud 230. Sensors 206 may include hardware sensors 208 and software sensors 210 that may be used for monitoring communications associated with client device 102. Hardware sensors 208 can include a camera sensor with face recognition that monitors photographs and video communications, microphone sensor to monitor voice messages, global positioning system (GPS) sensors to monitor location of client device 102, proximity sensors that can detect persons nearby or the like. Similarly, software sensors 210 may include software that are configured to monitor communications on client device 102 such as, for example, monitoring updates and information published to social networking sites, for example, to sites such as Facebook®, sensors to monitor phone call logs, SMS traffic or IM traffic. Hardware and software sensors 208, 210 may be configured to monitor user communications including monitoring user-created content by user 104 to others using client device 102 or other client devices. In some examples, user communications may include user-created online content in social networking sites and blogs, user-created text and email messages and user-created audio and video messages using client device 102 or other client devices using user 104 credentials. In embodiments, hardware and software sensors 208, 210 may be located on a client device 102 or, alternatively, hardware and software sensors 208, 210 may be a combination of cloud components that are located in cloud 230 and sensors located on client device 102. It is to be appreciated that a user 104 may have to opt-in or consent to being monitored by providing user log-in information for accounts of user 104 on social networking sites, email accounts, blogs or the like. While the discussion in FIG. 2 refers only to one client device 102, one network 228 and one cloud 230, it is to be appreciated that system architecture 200 may also be implemented using any number of client devices, networks and cloud service systems. In other embodiments, one cloud service system may communicate with any number of client devices for monitoring communications between these client devices.

Also shown in FIG. 2, agent 212 is communicatively coupled to sensor 206 and may be configured to monitor user activity by user 104 online via network 228. Agent 212 includes modules that may be located on client device 102 and/or cloud 230. Agent 212 may include a social evaluator module 214, a risk assessment module 216 and a content monitor module 218.

Social evaluator module 214 may be configured to utilize sensors 206 to determine social connections of user 104. For example, social evaluator module 214 may be configured to monitor communications by client device 102, including audio, video and text communications, and proximity information from proximity sensors in order to determine other users (or people) who may be in the same social network as user 104 as well to determine the context of the communications and relationships within the social network. Social evaluator module 214 may continuously update the context of people in order to determine abrupt changes or abnormal behavior within the relationship. In an example, social evaluator module 214 may determine the relationship between people in the social network, how often they interact and the level of trust between them by monitoring the frequency of communication between them using client device 102.

Risk assessment module 216 may be configured to monitor user-generated content of user 104 on client device 102 that is shared with other people and assess the risk of sharing the content. Risk assessment module 216 may use Natural Language Processing (NLP) and image recognition to determine whose information is shared and with whom. Risk assessment module 216 may be configured to alert user 104 as to the communication that user 104 is about to share with other people using one or more labels. For example, risk assessment module 216 may flag a communication by providing labels that alert the user as to the communication such as, for example, “Too much sharing” or “Risky behavior”. Risk assessment module 216 may also monitor the behavior of others in a user's social network. For example, risk assessment module 216 may monitor publicly available communications of others in user 104's social network by looking at their publicly available online behavior on social networking sites (for example, on Facebook®, Twitter®, blogs, mailing lists, forums, or the like) to determine their propensity or willingness to “gossip” or manipulate “others”. Based upon this monitoring, risk assessment module 216 may provide a score that is used to determine the risk of receiving information or content from others in the user's social network.

Content monitor module 218 may be configured to monitor content about user 104 that is available in cloud 230. Monitored content about user 104 can include content of user 104 that is publicly available or content of user 104 that is privately available to a subset of people in a social network or group, for example, user content that is available to a subset of people that may receive the content through an account of user 104 in Facebook®. Content monitor module 218 may also monitor any duplication of content (for example, duplication of content through sharing on Facebook®, etc.) or referencing the content (for example, citing the content in a professional citation) and may also identify any breaches or vulnerabilities online that become known and determine if these breaches may put user 104 at risk. In embodiments, content monitor module 218 may use NLP or image processing to monitor content in cloud 230. Also, content monitor module 218 may create signatures and markers for the content to authenticate that the content was generated by user 104.

Data storage device(s) 220 may be configured to store information that is identified and gathered by agent 212. Data storage device(s) 220 may be embodied as any type of device or devices configured for short-term or long-term storage of data such as, for example, memory devices and circuits, memory cards, hard disk drives, solid-state drives, or other data storage devices.

Applications manager 222 is in communication with data storage device 220 and is configured to receive data from data storage device(s) 220 as well as information from cloud 230. Applications manager 222 may be configured to analyze the information received from data storage 220 and cloud 230 in order to provide alerts to user 104 if the communication is deemed risky and/or the intended recipient is not trustworthy. For example, Applications manager 222 may be configured to monitor user behavior of user 104 on client device 102 as it relates to user activity through one or more channels, for example, accessing websites and sharing content by user 104 directly via client device 102, via social networking sites or via other communications including email, audio, video, weblogs or the like. Applications manager 222 may be configured to interact with one or more native applications on user client device 102 in order to provide alerts and warning messages based on user activity using these native applications online or on client device 102. Applications manager 222 includes recommender module 224 and reputation advisor module 226.

Recommender module 224 includes algorithms that are configured to monitor communications via sensors 206 and provide recommendations to user 104 on user client device 102. Recommender module 224 may be configured to provide a recommendation to user 104 regarding communications that are created on client device 102 prior to transmitting the message online or to an intended recipient. For example, if user 104 generates an email via an email application for a recipient that is trustworthy, recommender module 224 may provide a recommendation to user 104 via a graphical user interface (GUI) or another pop-up window prior to user 104 sending the communication notifying user 104 that the recipient is trustworthy and/or the message does not contain information that may pose a risk to user 104. Also, reputation advisor module 226 may be configured to provide a warning to user 104 based on risky/inappropriate communications and/or risky/inappropriate recipients. For example, if user 104 uses user client device 102 to generate a communication that is not appropriate for sharing to a particular recipient, reputation advisor module 226 may provide a warning message via, for example, pop-ups associated with the application being used for the communication that sending the communication is “Risky behavior” or there is “too much sharing” with the intended recipient.

Cloud 230 is embodied as a cloud service system that may be configured to aggregate online user-generated content and anonymize the information to determine generally acceptable behavior for determining a security risk score and social behavior score that is provided to user 104. Cloud 230 may receive user-generated content from social networking sites and determine social behavior risk and security risk scores via a policy and trend services engine 232. Policy and trend services engine 232 may be configured to analyze the aggregated information in order to determine a trend in acceptable behavior (i.e., quantify behavior) by category for example, quantify acceptable behavior by group. Policy and trend services engine 232 may utilize crowd sourced analysis or peer groups by crawling social websites to monitor and categorize content posted by user 104 and also monitor activity of a group that is based on a group relationship with user 104 that is available from sensors 206. Policy and trend services engine 232 may determine a user 104's social behavior and security risk scores based on online user information, social norms and crowd-sourced information. As group dynamics change over time, a user's social behavior and security risk scores may also change. A user's social behavior and security risk scores may be used to provide recommendations to user 104 via reputation manager engine 106 (FIG. 1) with respect to online social risk status improvement of user 104 (FIG. 1), risky user behavior that may subject user to online fraud, or the like. In an embodiment, policy and trend services engine 232 may use crowd-sourced analysis to assign colors to a discussion taxonomy based on the content and determine whether policy and trend services engine 232 may educate user 104 via user interface 120 about the potential for privacy leakage and suggestions for making changes to existing posts via applications manager 222 as well as to restrict further posts by limiting amount of personal information shared by user 104 that may affect user 104's security risk score.

FIG. 3 illustrates an example user interface 300 generated by according to one embodiment. User interface 300 may be implemented as user interface 120 (FIG. 1) and includes section 302 that provides information regarding potential for privacy leakage and attacks based on online user behavior, user's online personality, and user activity online. Recommendation section 302 may provide information regarding steps that were used to protect the user from possible attacks to the user's social risk status and may provide information that relates to user activity on posting inappropriate content that user 104 received warnings or alerts previously on user client device 102 (FIG. 1). Section 304 may be configured to provide alerts regarding risky user behavior and credits that caused a more favorable social behavior score.

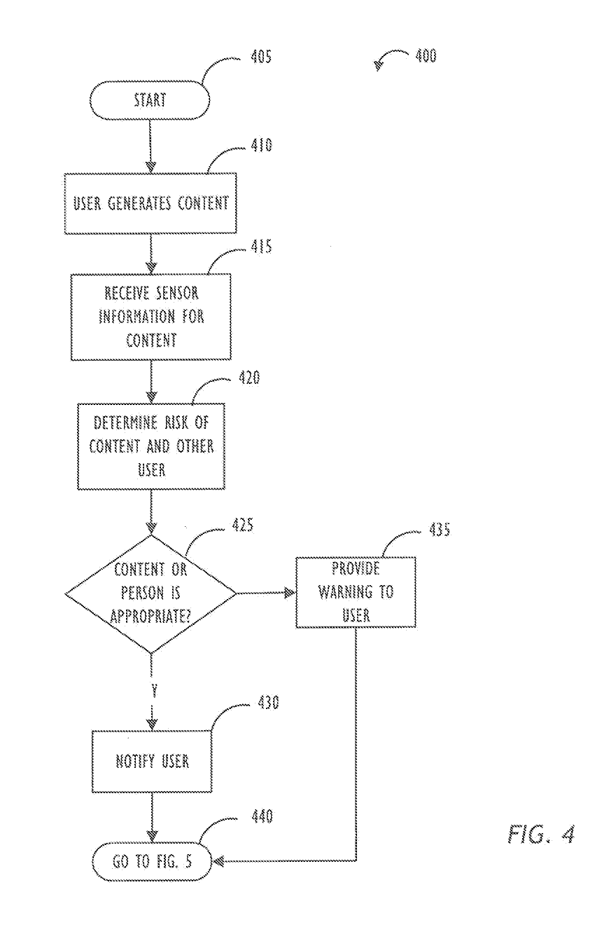

FIG. 4 is a flowchart illustrating a process 400 that may be used for monitoring user-generated content for sharing on a user client device according to one embodiment. As process 400 is performed by system 200, FIG. 2 is also referenced in the description of process 400.

Process 400 begins in step 405. In 410, a user may utilize a user client device, for example, client device 102 (FIG. 1) to generate content. For example, user 104 may create a photograph image using a camera and utilize a web browser on client device 102 (FIG. 1) in order to upload a photograph to a social networking site. In 415, sensor information may be received for the user-generated content. For example, hardware and software sensors 208, 210 may monitor real-time user-generated content including text, images, metadata in images or the like. In 420, a risk of sharing the content with another person may be determined. For example, the sensor may pause user activity in order for agent 212 to determine the risk in the shared content and the risk of sharing the content with the other person. For example, an evaluator module 214 in agent 212 may determine the relationship between user 104 (FIG. 1) and the other person in the user's social network. Other agents, such as risk assessment module 216 may use NLP, Bayesian machine learning algorithms and image recognition algorithms to determine the content of the information that is being shared and with whom. Risk assessment module 216 may utilize the other person's publicly available online behavior to determine the other person's propensity or willingness to “gossip” or manipulate “others.” Trend information online may be also analyzed to determine a trend in acceptable behavior as it relates to user-generated content. Additionally, peer group analysis may be used to determine if one or more other people in user's social network have shared or disseminated private information of user 104 to others. In 425, if the content is deemed appropriate to share online with the other person, (i.e., step 425=“Y”), then, in 430, user 104 may be notified that content may be shared with the other person. However, in 425, if content is deemed to not be appropriate to share or if the other person is not trustworthy with the content (i.e., step 425=“N”), then, in 435, a warning message may be provided to user 104 (FIG. 1). For example, applications manager 222 may flag the communication as inappropriate by providing labels in a pop-up window that alert user 104 (FIG. 1) with warning messages such as, for example, “Too much sharing” or “Risky behavior”. In another embodiment, this warning message may be repeated to user 104 (FIG. 1) based on predetermined preferences that have been set by user 104 (FIG. 1). A user may proceed to posting the online information despite the warning. In an embodiment, user 104 may set user preferences on client device 102 that determine how often the user 104 may receive recommendations, alerts and warning as well as determine whether to suspend user activity based on inflammatory messages. In other embodiment, warning messages may be provided based on learning user preferences by evaluating past user behavior when receiving alerts, receiving warnings and receiving recommendations.

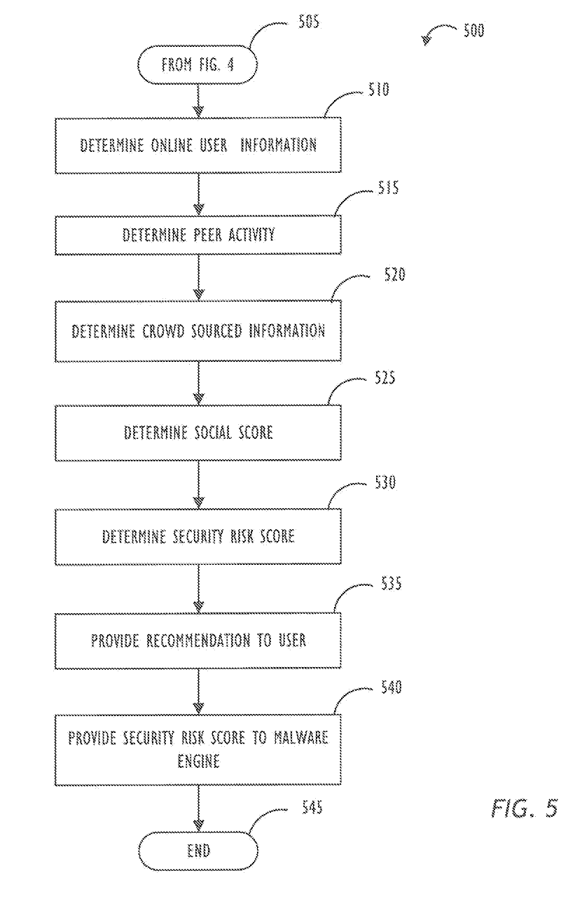

FIG. 5 is a flowchart illustrating a technique for fraud detection and online social risk status improvement by utilizing a social score and a security risk score of a user according to one embodiment. With continued reference to FIGS. 1 and 2, Process 500 begins in step 505.

In 510, agent 212 determines online user activity. For example, content monitor 218 may monitor content about user 104 that is available online in cloud 230. User content about user 104 may include private content that may be accessible on a user account of one or more social networking sites as well as publicly available content about user 104 that may or may not have been created by user 104. In an example, private content can include content that may be propagated through a social network and, as a result, may be localized to a branch of the social network and available to a limited group of people in the user's social network. Additionally, content monitor module 218 may determine any duplication of content that is publicly available online.

In 515, activity of peer groups that relate to user 104 may be determined. For example, a graph of user connections of user 104 may be determined and the user connections traced to determine how these user connections act on the online information of user 104. The determination may be made based on whether user-generated content is duplicated by user connections, whether user connections share the content with others online (e.g., propensity of user connections to gossip about user-generated content), or whether user groups may share other user's information with user 104. Sharing of other user's information may also indicate the user's connections propensity to gossip or be less trustworthy.

In 520, crowd sourced information online may be determined. For example, online behavior related to user activity of user 104 (FIG. 1) is anonymized with other peer groups in order to determine social norms for generally acceptable behavior. For example, social trends for online user content for peer groups of user 104 may be determined.

In 525, a social score and a social behavior score for user 104 may be determined. Social score and social behavior score may be determined by determining whether user 104 accessed social networking sites like Facebook®, or the like and posted information and/or interacted with other users. Social behavior score may determine a social risk to user for the shared content by determining whether the shared content with other persons poses a risk based on the other persons reputation for sharing the content with others either intentionally or unintentionally (e.g., via malware). In an embodiment, social behavior score may also evaluate the content that is being shared with others. In another embodiment, social score may also be determined by accessing social networking sites and using NLP on user posted information to classify whether the information is positive or negative with respect to other users in the social networking group of user 104 and to what extent as well as using NLP analysis on contacts of user 104 to understand their reaction to user posts and how those posts affect their moods and emotions.

In 530, security risk score for user 104 may be determined. Security risk score may be determined by evaluating user behavior with respect to visiting websites or downloading online applications to user client device 102 and performing suspicious activity by using anonymizing software or making multiple unsuccessful attempts to access a plural number of websites online or the like. Security risk score may be determined by analyzing user behavior to anonymized behavior of a user's peer group or crowd sourced information in order to determine generally acceptable behavior of a group of user that are within a peer group of user 104. A lower security risk score indicates that online user behavior is low risk and similar to other users in the peer group. A higher security risk score indicates that online user behavior is high risk and posting online activity is outside the general norms of acceptable user behaviors for other users in the peer group.

In 535, recommendations may be communicated to user 104. For example, social behavior score, security score and social norms may be evaluated in determining whether user behavior conforms to generally acceptable social norms or, alternatively, user behavior is risky with respect to affecting a user's online social risk status and may subject user to possible online fraud. In an embodiment, social norms of peer groups may present a high-risk, and user behavior that conforms to these norms may be deemed high-risk and non-conformance may present a low-risk. In an embodiment, recommendations may be pushed to user 104 on client device 102 via reputation manager engine 106 for display on user interface 120, or a user 104 may access the information online via a dashboard. The recommendations may provide suggestions that user 104 may voluntarily take to make the user 104 safer online. In an embodiment, user behavior that generated a user's security score may be also identified (e.g., warning provided to user in step 435 based on user-generated content) so that user 104 may take further action to remove this online content and/or remove one or more other users from a social network of user 104 that disseminated private user content online without approval of user 104.

In 540, security risk score may be sent to malware engine 118. Security risk score may be exported into malware engine 118 to affect its performance on user client device 102 with respect to scanning for malware on user client device 102. Process 500 ends in step 545.

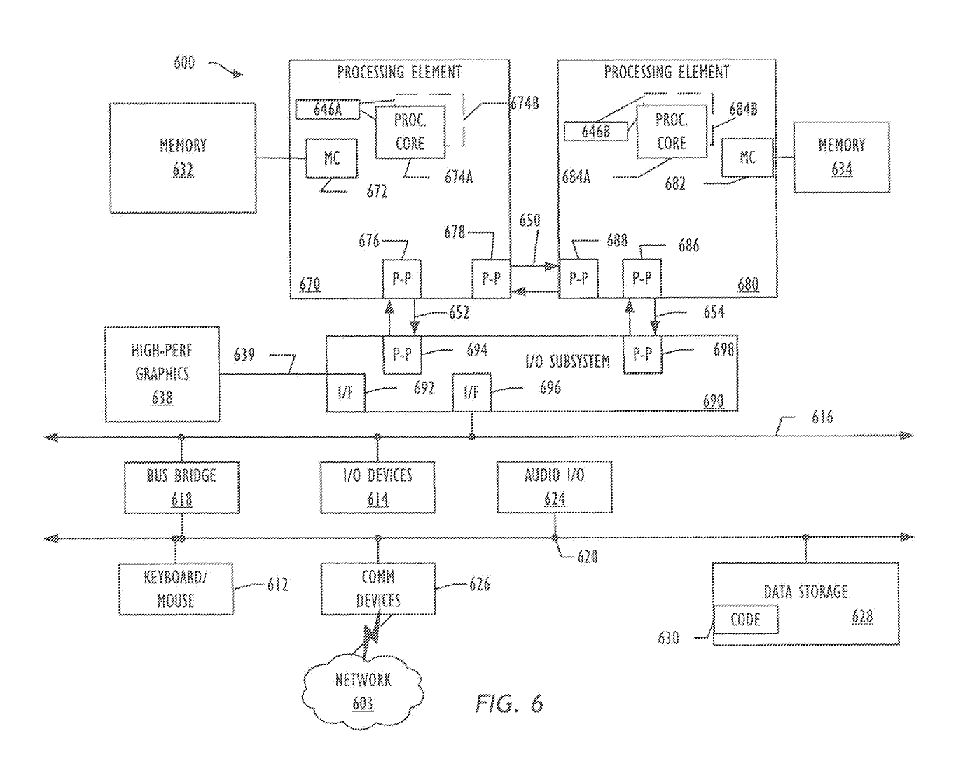

Referring now to FIG. 6, a block diagram illustrates a programmable device 600 that may be used within user client device 102 or cloud 230 in accordance with one embodiment. The programmable device 600 illustrated in FIG. 6 is a multiprocessor programmable device that includes a first processing element 670 and a second processing element 680. While two processing elements 670 and 680 are shown, an embodiment of programmable device 600 may also include only one such processing element.

Programmable device 600 is illustrated as a point-to-point interconnect system, in which the first processing element 670 and second processing element 680 are coupled via a point-to-point interconnect 650. Any or all of the interconnects illustrated in FIG. 6 may be implemented as a multi-drop bus rather than point-to-point interconnects.

As illustrated in FIG. 6, each of processing elements 670 and 680 may be multicore processors, including first and second processor cores (i.e., processor cores 674a and 674b and processor cores 684a and 684b). Such cores 674a, 674b, 684a, 684b may be configured to execute instruction code in a manner similar to that discussed above in connection with FIGS. 4-5. However, other embodiments may use processing elements that are single core processors as desired. In embodiments with multiple processing elements 670, 680, each processing element may be implemented with different numbers of cores as desired.

Each processing element 670, 680 may include at least one shared cache 646. The shared cache 646a, 646b may store data (e.g., instructions) that are utilized by one or more components of the processing element, such as the cores 674a, 674b and 684a, 684b, respectively. For example, the shared cache may locally cache data stored in a memory 632, 634 for faster access by components of the processing elements 670, 680. In one or more embodiments, the shared cache 646a, 646b may include one or more mid-level caches, such as level 2 (L2), level 3 (L3), level 4 (L4), or other levels of cache, a last level cache (LLC), or combinations thereof.

While FIG. 6 illustrates a programmable device with two processing elements 670, 680 for clarity of the drawing, the scope of the present invention is not so limited and any number of processing elements may be present. Alternatively, one or more of processing elements 670, 680 may be an element other than a processor, such as an graphics processing unit (GPU), a digital signal processing (DSP) unit, a field programmable gate array, or any other programmable processing element. Processing element 680 may be heterogeneous or asymmetric to processing element 670. There may be a variety of differences between processing elements 670, 680 in terms of a spectrum of metrics of merit including architectural, microarchitectural, thermal, power consumption characteristics and the like. These differences may effectively manifest themselves as asymmetry and heterogeneity amongst processing elements 670, 680. In some embodiments, the various processing elements 670, 680 may reside in the same die package.

First processing element 670 may further include memory controller logic (MC) 672 and point-to-point (P-P) interconnects 676 and 678. Similarly, second processing element 680 may include a MC 682 and P-P interconnects 686 and 688. As illustrated in FIG. 6, MCs 672 and 682 couple processing elements 670, 680 to respective memories, namely a memory 632 and a memory 634, which may be portions of main memory locally attached to the respective processors. While MC logic 672 and 682 is illustrated as integrated into processing elements 670, 680, in some embodiments the memory controller logic may be discrete logic outside processing elements 670, 680 rather than integrated therein.

Processing element 670 and processing element 680 may be coupled to an I/O subsystem 690 via respective P-P interconnects 676 and 686 through links 652 and 654. As illustrated in FIG. 6, I/O subsystem 690 includes P-P interconnects 694 and 698. Furthermore, I/O subsystem 690 includes an interface 692 to couple I/O subsystem 690 with a high performance graphics engine 638. In one embodiment, a bus (not shown) may be used to couple graphics engine 638 to I/O subsystem 690. Alternately, a point-to-point interconnect 639 may couple these components.

In turn, I/O subsystem 690 may be coupled to a first link 616 via an interface 696. In one embodiment, first link 616 may be a Peripheral Component Interconnect (PCI) bus, or a bus such as a PCI Express bus or another I/O interconnect bus, although the scope of the present invention is not so limited.

As illustrated in FIG. 6, various I/O devices 614, 624 may be coupled to first link 616, along with a bridge 618 which may couple first link 616 to a second link 620. In one embodiment, second link 620 may be a low pin count (LPC) bus. Various devices may be coupled to second link 620 including, for example, a keyboard/mouse 612, communication device(s) 626 (which may in turn be in communication with the computer network 603), and a data storage unit 628 such as a disk drive or other mass storage device which may include code 630, in one embodiment. The code 630 may include instructions for performing embodiments of one or more of the techniques described above. Further, an audio I/O 624 may be coupled to second bus 620.

Note that other embodiments are contemplated. For example, instead of the point-to-point architecture of FIG. 6, a system may implement a multi-drop bus or another such communication topology. Although links 616 and 620 are illustrated as busses in FIG. 6, any desired type of link may be used. Also, the elements of FIG. 6 may alternatively be partitioned using more or fewer integrated chips than illustrated in FIG. 6.

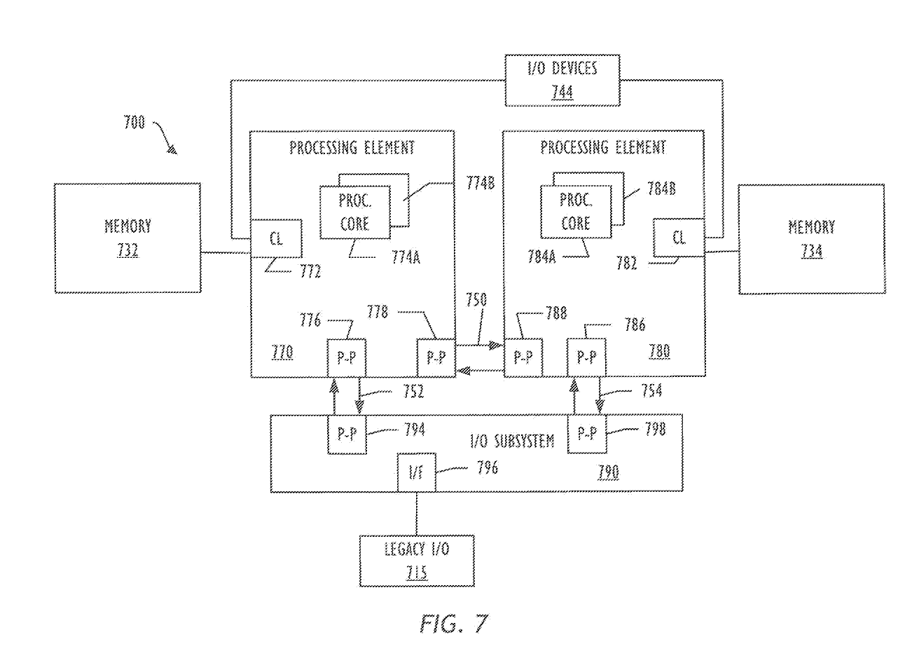

Referring now to FIG. 7, a block diagram illustrates a programmable device 700 according to another embodiment. Certain aspects of FIG. 6 have been omitted from FIG. 7 in order to avoid obscuring other aspects of FIG. 7.

FIG. 7 illustrates that processing elements 770, 780 may include integrated memory and I/O control logic (“CL”) 772 and 782, respectively. In some embodiments, the 772, 782 may include memory control logic (MC) such as that described above in connection with FIG. 6. In addition, CL 772, 782 may also include I/O control logic. FIG. 7 illustrates that not only may the memories 732, 734 be coupled to the 772, 782 but also that I/O devices 744 may also be coupled to the control logic 772, 782. Legacy I/O devices 715 may be coupled to the I/O subsystem 790 by interface 796. Each processing element 770, 780 may include multiple processor cores, illustrated in FIG. 7 as processor cores 774A, 774B, 784A and 784B. As illustrated in FIG. 7, I/O subsystem 790 includes P-P interconnects 794 and 798 that connect to P-P interconnects 776 and 786 of the processing elements 770 and 780 with links 752 and 754. Processing elements 770 and 780 may also be interconnected by link 750 and interconnects 778 and 788, respectively.

The programmable devices depicted in FIGS. 6 and 7 are schematic illustrations of embodiments of programmable devices which may be utilized to implement various embodiments discussed herein. Various components of the programmable devices depicted in FIGS. 6 and 7 may be combined in a system-on-a-chip (SoC) architecture.

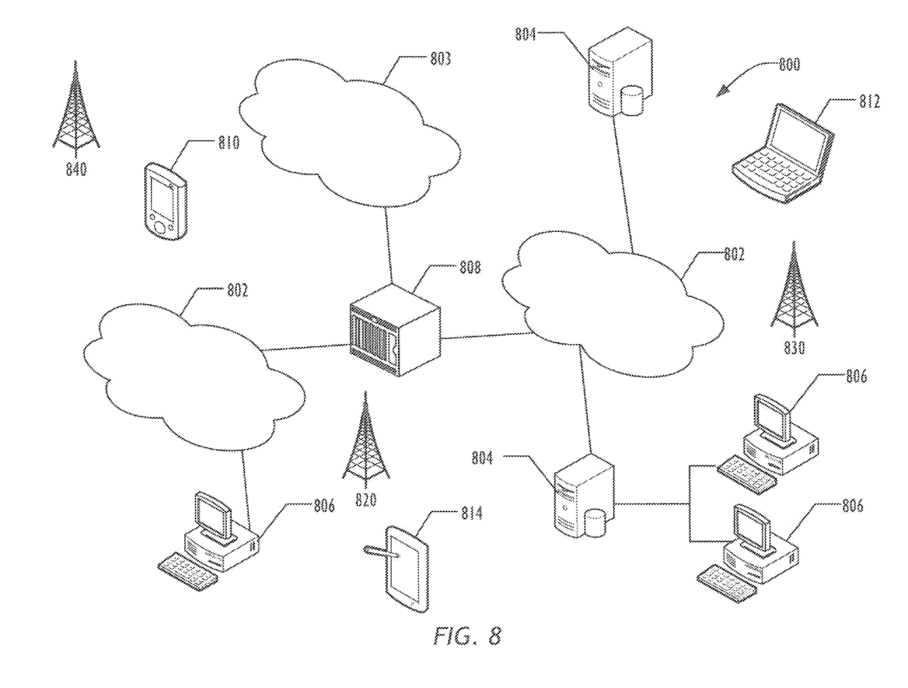

Referring now to FIG. 8, an example infrastructure 800 in which the techniques described above may be implemented is illustrated schematically. Infrastructure 800 contains computer networks 802. Computer networks 802 may include many different types of computer networks available today, such as the Internet, a corporate network or a Local Area Network (LAN). Each of these networks can contain wired or wireless programmable devices and operate using any number of network protocols (e.g., TCP/IP). Networks 802 may be connected to gateways and routers (represented by 808), end user computers 806, and computer servers 804. Infrastructure 800 also includes cellular network 803 for use with mobile communication devices. Mobile cellular networks support mobile phones and many other types of mobile devices. Mobile devices in the infrastructure 800 are illustrated as mobile phones 810, laptops 812 and tablets 814. A mobile device such as mobile phone 810 may interact with one or more mobile provider networks as the mobile device moves, typically interacting with a plurality of mobile network towers 820, 830, and 840 for connecting to the cellular network 803. Although referred to as a cellular network in FIG. 8, a mobile device may interact with towers of more than one provider network, as well as with multiple non-cellular devices such as wireless access points and routers 808. In addition, the mobile devices 810, 812 and 814 may interact with non-mobile devices such as computers 804 and 806 for desired services, which may include sharing content and determining a social behavior score and a security risk score described above. The functionality of cloud 230 or client 102 may be implemented in any device or combination of devices illustrated in FIG. 8; however, most commonly is implemented in a firewall or intrusion protection system in a gateway or router.

The following examples pertain to further embodiments.

Example 1 is machine readable medium, on which are stored instructions, comprising instructions that when executed cause a machine to: determine online user activity for a user; determine a social behavior score and a security risk score for the user; and provide one or more recommendations to the user responsive to the determining of the social behavior and the security risk scores for the user; wherein the online user activity includes private content and publicly available content about the user.

In Example 2, the subject matter of Example 1 can optionally include wherein the instructions that when executed cause the machine to determine online user activity comprise instructions that when executed cause the machine to analyze content on a social networking site associated with an account of the user.

In Example 3, the subject matter of Example 1 or 2 can optionally include, wherein the instructions further comprise instructions that when executed cause the machine to: determine online activity of peer groups related to the user; and determine social trends for the online activity.

In Example 4, the subject matter of Examples 1 to 3 can optionally include, wherein the instructions further comprise instructions that when executed cause the machine to determine whether the online user activity is high risk or low risk with respect to at least one of the peer groups and to an immediate social network of the user responsive to determining the security risk score.

In Example 5, the subject matter of Examples 1 to 4 can optionally include, wherein the instructions further comprise instructions that when executed cause the machine to provide the security risk score to a malware engine for malware scanning of a user device associated with the user responsive to the determining of the security risk score.

In Example 6, the subject matter of Examples 1 to 5 can optionally include, wherein the instructions further comprise instructions that when executed cause the machine to provide user activity that generated the security risk score responsive to the determining of the security risk score.

In Example 7, the subject matter of Examples 1 to 6 can optionally include, wherein the instructions that when executed cause the machine to provide recommendations further comprise instructions that when executed cause the machine to provide information about user activity related to the security risk score.

In Example 8, the subject matter of Examples 1 to 7 can optionally include, wherein the instructions further comprise instructions that when executed cause the machine to monitor real-time user-generated content on a user device associated with the user.

In Example 9, the subject matter of Example 8 can optionally include, wherein the instructions further comprise instructions that when executed cause the machine to display a user interface to provide alerts on the user device responsive to the real-time monitoring of the user-generated content.

In Example 10, the subject matter of Examples 1 to 9 can optionally include, wherein the instructions further comprise instructions that when executed cause the machine to determine at least one of whether the user-generated content that is shared to a second person will be leaked by the second person to others; and determine the risk to the user based on the leak by the second person.

Example 11 is a method for a security risk profile of a user, comprising: determining online user activity for the user; determining a social behavior score and a security risk score for the user; and providing one or more recommendations to the user responsive to the determining of the social behavior and the security risk scores for the user; wherein the online user activity includes private content and publicly available content about the user.

In Example 12, the subject matter of Example 11 can optionally include analyzing content on a social networking site associated with an account of the user.

In Example 13, the subject matter of Example 10 or 11 can optionally include determining online activity of peer groups related to the user; and determining social trends for the online activity.

In Example 14, the subject matter of Examples 11 to 13 can optionally include determining whether the online user activity is high risk or low risk with respect to the peer groups and to an immediate social network of the user responsive to determining the security risk score.

In Example 15, the subject matter of Examples 11 to 14 can optionally include providing the security risk score to a malware engine for malware scanning of a user device associated with the user responsive to the determining of the security risk score.

In Example 16, the subject matter of Examples 11 to 15 can optionally include providing user activity that generated the security risk score responsive to the determining of the security risk score.

In Example 17, the subject matter of Examples 11 to 16 can optionally include monitoring real-time user-generated content on a user device associated with the user.

In Example 18, the subject matter of Examples 17 can optionally include displaying a user interface to provide alerts on the user device responsive to the real-time monitoring of the user-generated content.

In Example 19, the subject matter of Examples 11 to 18 can optionally include providing information about user activity related to the security risk score.

In Example 20, the subject matter of Examples 11 to 19 can optionally include determining at least one of whether the user-generated content that is shared to a second person will be leaked by the second person to others; and determine the risk to the user based on the leak by the second person.

Example 21 is a computer system for a security risk profile of a user, comprising: one or more processors; and a memory coupled to the one or more processors, on which are stored instructions, comprising instructions that when executed cause one or more of the processors to: determine online user activity for the user; determine a social behavior score and a security risk score for the user; and provide one or more recommendations to the user responsive to the determining of the social behavior and the security risk scores for the user; wherein the online user activity includes private content and publicly available content about the user.

In Example 22, the subject matter of Example 21 can optionally include, wherein the instructions to determine online user activity comprise instructions that when executed cause the one or more processors to analyze content on a social networking site associated with an account of the user.

In Example 23, the subject matter of Examples 21 to 22 can optionally include, wherein the instructions further comprise instructions that when executed cause the one or more processors to: determine online activity of peer groups related to the user; and determine social trends for the online activity.

In Example 24, the subject matter of Examples 21 to 23 can optionally include, wherein the instructions further comprise instructions that when executed cause the one or more processors to determine whether the online user activity is high risk or low risk with respect to the peer groups and to an immediate social network of the user responsive to determining the security risk score.

In Example 25, the subject matter of Examples 21 to 24 can optionally include, wherein the instructions further comprise instructions that when executed cause the one or more processors to provide the security risk score to a malware engine for malware scanning of a user device associated with the user responsive to the determining of the security risk score.

In Example 26, the subject matter of Examples 21 to 25 can optionally include, wherein the instructions further comprise instructions that when executed cause the one or more processors to provide user activity that generated the security risk score responsive to the determining of the security risk score.

In Example 27, the subject matter of Examples 21 to 26 can optionally include, wherein the instructions further comprise instructions that when executed cause the one or more processors to monitor real-time user-generated content on a user device associated with the user.

In Example 28, the subject matter of Example 27 can optionally include, wherein the instructions further comprise instructions that when executed cause the one or more processors to display a user interface to provide alerts on the user device responsive to the real-time monitoring of the user-generated content.

In Example 29, the subject matter of Examples 21 to 28 can optionally include, wherein the instructions further comprise instructions that when executed cause the one or more processors to provide information about user activity related to the security risk score.

In Example 30, the subject matter of Examples 21 to 29 can optionally include, wherein the instructions further comprise instructions that when executed cause the one or more processors to determine at least one of whether the user-generated content that is shared to a second person will be leaked by the second person to others; and determine the risk to the user based on the leak by the second person.

Example 31 is a computer system for security risk profile of a user, comprising: one or more processors; and a memory coupled to the one or more processors, on which are stored instructions, comprising instructions that when executed cause one or more of the processors to: generate online content for a user on a user device; and receive via a user interface real-time alerts on the user device responsive to the generating of the online content.

In Example 32, the subject matter of Example 31 can optionally include, wherein the instructions further comprise instructions that when executed cause the one or more processors to receive a social behavior score and a security risk score for the user.

In Example 33, the subject matter of Examples 31 to 32 can optionally include, wherein the instructions further comprise instructions that when executed cause the one or more processors to receive via the user interface one or more recommendations to the user responsive to the receiving the social behavior and the security risk scores for the user.

In Example 34, the subject matter of Examples 31 to 33 can optionally include, further comprising a malware engine and wherein the instructions further comprise instructions that when executed cause the one or more processors to receive the security risk score at the malware engine for malware scanning of the user device.

In Example 35, the subject matter of Examples 31 to 34 can optionally include, wherein the instructions further comprise instructions that when executed cause the one or more processors to receive user activity that created the security risk score.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A machine readable medium, on which are stored instructions, comprising instructions that when executed cause a machine to:
determine online user activity for a user;
determine a social behavior score and a security risk score for the user; and
provide one or more recommendations to the user responsive to the determining of the social behavior and the security risk scores for the user;
wherein the online user activity includes private content and publicly available content about the user.

2. The machine readable medium of claim 1, wherein the instructions that when executed cause the machine to determine online user activity comprise instructions that when executed cause the machine to analyze content on a social networking site associated with an account of the user.

3. The machine readable medium of claim 1, wherein the instructions further comprise instructions that when executed cause the machine to:
determine online activity of peer groups related to the user; and
determine social trends for the online activity.

4. The machine readable medium of claim 3, wherein the instructions further comprise instructions that when executed cause the machine to determine whether the online user activity is high risk or low risk with respect to at least one of the peer groups and to an immediate social network of the user responsive to determining the security risk score.

5. The machine readable medium of claim 1, wherein the instructions further comprise instructions that when executed cause the machine to provide the security risk score to a malware engine for malware scanning of a user device associated with the user responsive to the determining of the security risk score.

6. The machine readable medium of claim 1, wherein the instructions further comprise instructions that when executed cause the machine to provide user activity that generated the security risk score responsive to the determining of the security risk score.

7. The machine readable medium of claim 1, wherein the instructions that when executed cause the machine to provide recommendations further comprise instructions that when executed cause the machine to provide information related to user activity related to the security risk score.

8. The machine readable medium of claim 1, wherein the instructions further comprise instructions that when executed cause the machine to monitor real-time user-generated content on a user device associated with the user.

9. The machine readable medium of claim 8, wherein the instructions further comprise instructions that when executed cause the machine to display a user interface to provide alerts on the user device responsive to the real-time monitoring of the user-generated content.

10. The machine readable medium of claim 1, wherein the instructions further comprise instructions that when executed cause the machine to determine at least one of whether the user-generated content that is shared to a second person will be leaked by the second person to others; and determine the risk to the user based on the leak by the second person.

11. A computer system for a security risk profile of a user, comprising:
one or more processors; and
a memory coupled to the one or more processors, on which are stored instructions, comprising instructions that when executed cause one or more of the processors to:
determine online user activity for the user;
determine a social behavior score and a security risk score for the user; and
provide one or more recommendations to the user responsive to the determining of the social behavior and the security risk scores for the user;
wherein the online user activity includes private content and publicly available content about the user.

12. The computer system of claim 11, wherein the instructions to determine online user activity comprise instructions that when executed cause the one or more processors to analyze content on a social networking site associated with an account of the user.

13. The computer system of claim 11, wherein the instructions further comprise instructions that when executed cause the one or more processors to:
determine online activity of peer groups related to the user; and
determine social trends for the online activity.

14. The computer system of claim 13, wherein the instructions further comprise instructions that when executed cause the one or more processors to determine whether the online user activity is high risk or low risk with respect to the peer groups and to an immediate social network of the user responsive to determining the security risk score.

15. The computer system of claim 11, wherein the instructions further comprise instructions that when executed cause the one or more processors to provide the security risk score to a malware engine for malware scanning of a user device associated with the user responsive to the determining of the security risk score.

16. The computer system of claim 11, wherein the instructions further comprise instructions that when executed cause the one or more processors to provide user activity that generated the security risk score responsive to the determining of the security risk score.

17. The computer system of claim 11, wherein the instructions further comprise instructions that when executed cause the one or more processors to monitor real-time user-generated content on a user device associated with the user.

18. The computer system of claim 17, wherein the instructions further comprise instructions that when executed cause the one or more processors to display a user interface to provide alerts on the user device responsive to the real-time monitoring of the user-generated content.

19. The computer system of claim 11, wherein the instructions further comprise instructions that when executed cause the one or more processors to provide information about user activity related to the security risk score.

20. The computer system of claim 11, wherein the instructions further comprise instructions that when executed cause the one or more processors to determine at least one of whether the user-generated content that is shared to a second person will be leaked by the second person to others; and determine the risk to the user based on the leak by the second person.

21. A method for a security risk profile of a user, comprising:
determining by a cloud service online user activity for the user;
determining by the cloud service a social behavior score and a security risk score for the user; and
providing by the cloud service one or more recommendations to the user responsive to the determining of the social behavior and the security risk scores for the user;
wherein the online user activity includes private content and publicly available content about the user.

22. The method of claim 21, further comprising checking a social networking site associated with an account of the user.

23. The method of claim 21, further comprising:
determining online activity of peer groups related to the user; and
determining social trends for the online activity.

24. The method of claim 23, further comprising determining whether the online user activity is high risk or low risk with respect to the peer groups responsive to determining the security risk score.

25. The method of claim 21, further comprising providing the security risk score to a malware engine responsive to the determining of the security risk score, wherein the malware engine is configured for malware scanning of a user device associated with the user.
